(19) United States
(12) Patent Application Publication
(10) Pub. No.: US 2015/0120738 A1
(43) Pub. Date: Apr. 30, 2015

(54) SYSTEM AND METHOD FOR DOCUMENT CLASSIFICATION BASED ON SEMANTIC ANALYSIS OF THE DOCUMENT

(71) Applicant: Venkat Srinivasan, Weston, MA (US)

(72) Inventor: Venkat Srinivasan, Weston, MA (US)

(73) Assignee: RAGE FRAMEWORKS, INC., Dedham, MA (US)

(21) Appl. No.: 14/582,587

(22) Filed: Dec. 24, 2014

Related U.S. Application Data
(63) Continuation-in-part of application No. 12/963,907, filed on Dec. 9, 2010.

(51) Int. Cl. G06F 17/30

(52) U.S. Cl. CPC G06F 17/30598; G06F 17/30011
USPC 707/739

(57) ABSTRACT

A computer based method and system for classifying a document into one or more categories. The method and system can be configured to identify one or more cluster of clauses or sentences from a plurality of semantically similar clauses of the document and determine one or more representative concepts for each cluster of the document. Accordingly, one or more categories for the document are determined from the one or more representative concepts and the document is classified into the one or more categories.

### CROSS REFERENCE TO RELATED APPLICATIONS

This application is a CIP of U.S. patent application Ser. No. 12/963,907 filed Dec. 9, 2010, the disclosure of which is hereby incorporated by reference. This application is also related to U.S. patent application Ser. No. ______ filed ______ entitled “SYSTEM AND METHOD FOR GENERATING A TRACTABLE SEMANTIC NETWORK FOR A CONCEPT” and to U.S. patent application Ser. No. ______ filed ______ entitled “SYSTEM AND METHOD FOR DETERMINING THE MEANING OF A DOCUMENT WITH RESPECT TO A CONCEPT”. The disclosure of these applications are also hereby incorporated by reference.

### TECHNICAL FIELD

The present application relates generally to natural language processing technology. In particular, the application relates to a computer based system and method for tractable, model-driven classification of a document into one or more categories through semantic analysis of the document.

### BACKGROUND OF THE INVENTION

Document classification is a well recognized need and has numerous applications in real life. The most common example of document classification is the now ubiquitous search on the internet. When a user types in a search phrase, the search engine has to find all documents that can be categorized to the search phrase the user is interested in. Another example is the discovery process in litigation, where often millions of documents large and small have to be processed and classified into specific categories. Yet another example is in knowledge management where documents have to be classified into different categories based on their relevance and fit. Classification of the documents can be performed manually or automatically with little or no user intervention. In an instance, a document management system includes automated classifiers for automatically classifying the document into the one or more categories.

Typically, automated classifiers can be configured to employ one or more statistical methods wherein firstly, a statistical model is developed from a set of training documents and afterwards, an unclassified document is classified into the one or more categories by applying the statistical model. There are a variety of statistical approaches available for the purpose ranging from naïve Bayes classifiers to support vector machines. All statistical classifiers irrespective of approach have several limitations. First, given the large scale nature of the problem, to develop a robust statistical classifier, one needs a large homogeneous training set with respect to the problem being solved. Second, statistical models are black boxes and not tractable. Users will not have the ability to understand the precise reason behind the classification outcome. Third, statistical classifiers are largely frequency or word pattern based. Given the large number of ambiguous words in any word based language like English, statistical classifiers do not reflect a fine grained context for classification. There is even a more complex form of such ambiguity which occurs in the form of phrases which are semantically equivalent in their usage in a document but cannot be determined to be so without some external input. Such systems are unable to decipher whether a particular word is used in a different context within the different sections of the same document. Similarly, these systems are limited in identifying scenarios where two different words (e.g., factory output or production from a unit) may have substantially identical meanings in the different sections of the document. The restriction to process the content of the document matching on the level of individual words can generate inaccuracies while classifying the document into the one or more categories. Therefore there exists a need for a system and a method for a context based, tractable classification of documents. The system and method should also be extendable to incorporate user provided additional context without any additional programming.

### SUMMARY OF THE INVENTION

According to an aspect of the invention, disclosed is a computer implemented system and method for classifying a document into one or more categories or topics. The method comprising: generating at least one cluster from a plurality of semantically similar clauses of the document; identifying a first concept from a plurality of concepts of the at least one cluster such that the first concept represents at least a portion of content disclosed in the at least one cluster; determining a at least one category for the document using the first concept; and classifying the document based on the at least one category.

The method further includes identifying a first variant of the first concept from a plurality of variants of the first concept within the at least one cluster; and indicating the first variant of the first concept as a representative of the plurality of variants of the first concept of the at least one cluster. The first variant of the first concept comprises a noun phrase.

In an embodiment, a system for classifying the document is disclosed. The system comprising: a cluster generating module configured to generate at least one cluster from a plurality of semantically similar clauses of the document, wherein the at least one cluster comprises a plurality of concepts; a document classifier comprising: a cluster concept identifier configured to identify a first concept from the plurality of concepts of the at least one cluster such that the first concept represents at least a portion of content disclosed in the at least one cluster; a categorizer configured to determine a at least one category for the document using the first concept; and at least one classification rule comprising instruction to classify the document based on the at least one category.

In an embodiment, a method for identifying a representative concept for a cluster of the document is disclosed. The method comprising: generating a first cluster from a plurality of co-referential clauses or sentences of the document; identifying a plurality of noun phrases within the first cluster; determining at least one group of noun phrases from the plurality of noun phrases such that each noun phrase member in the at least one group is a variant of other noun phrase member of the at least one group; identifying the at least noun phrase member as a representative of the at least one group; and determining a first concept representing at least a portion of content disclosed in the first cluster using the representative noun phrase member of the at least one group.

Each component of the system is driven by a set of externalized rules and configurable parameters, generically referred to as the Configuration Module in the detailed description. This makes the system adaptable and extensible without any programming.

In an extension to the above system and method, it can integrate additional contextual expertise provided by the user without any additional programming.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

For a more complete understanding of exemplary embodiments of the present invention, reference is now made to the following descriptions taken in connection with the accompanying drawings in which:

FIG. 1 illustrates an exemplary embodiment of a computing device configured to classify a document according to one or more embodiments of the invention;

FIG. 2 illustrates an exemplary embodiment of a computing environment for classifying the document extracted from a corpus according to one or more embodiments of the invention;

FIG. 3 illustrates an exemplary embodiment of a client server computing environment for classifying the document according to one or more embodiments of the invention;

FIG. 4 illustrates an exemplary embodiment of a functional block diagram for controlling the execution of language processing modules according to one or more embodiments of the invention;

FIG. 5 illustrates an exemplary embodiment of a block diagram for a text processing layer of the language processing modules according to one or more embodiments of the invention;

FIGS. 6A and 6B illustrate an exemplary embodiment of an outcome from one or more modules of the text processing layer of the language processing modules according to one or more embodiments of the invention;

FIG. 7 illustrates an exemplary embodiment of a block diagram for a natural language processing layer of the language processing modules according to one or more embodiments of the invention;

FIGS. 8A and 8B illustrates an exemplary embodiment of a outcome from one or more modules of the natural language processing layer according to one or more embodiments of the invention;

FIG. 9 illustrates an exemplary embodiment of a block diagram for a linguistic analysis layer of the language processing modules according to one or more embodiments of the invention;

FIGS. 10A, 10B and 10C illustrates an exemplary embodiment of an outcome from one or more modules of the linguistic analysis layer according to one or more embodiments of the invention;

FIG. 11 illustrates an exemplary embodiment of a functional block diagram for classifying the document according to one or more embodiments of the invention;

FIG. 12 illustrates an exemplary embodiment of a method for classifying the document according to one or more embodiments of the invention; and

FIG. 13 illustrates an exemplary embodiment of a method for determining representative concept of a cluster of the document according to one or more embodiments of the invention.

### DETAILED DESCRIPTION OF THE PREFERRED EMBODIMENTS

The methods and systems described herein can classify the document through various approaches. In a first approach the methods and systems described herein can be configured to determine conceptual clusters in the document. Such clusters are found by identifying semantic similarities between all sentences and paragraphs in the document. Such semantic similarity includes co-referential relationships, conceptual relationships, and ontological relationships between the one or more sentences of the clusters. In an example, the methods and systems described herein can be configured to implement both anaphoric and cataphoric referential relationships to determine the semantic similarities between the sentences of the document.

Further, one or more concepts from the clusters are identified and the one or more categories for the document can be derived from the one or more concepts of the clusters. The first approach is also referred to as an unsupervised approach or unassisted approach for classifying the document. In a second approach, the methods and systems described herein implement additional contextual constraints and a framework that allows the implementation of pragmatic relationships relevant to the context. Further, the methods and systems described herein use concepts from sources outside the document to discover the additional one or more categories for the document. Such approach can also be referred to as a supervised or an assisted approach for determining the one or more categories for the document. These one or more approaches for classifying the document into the one or more categories are further explained in detailed manner with reference to the drawings of the description.

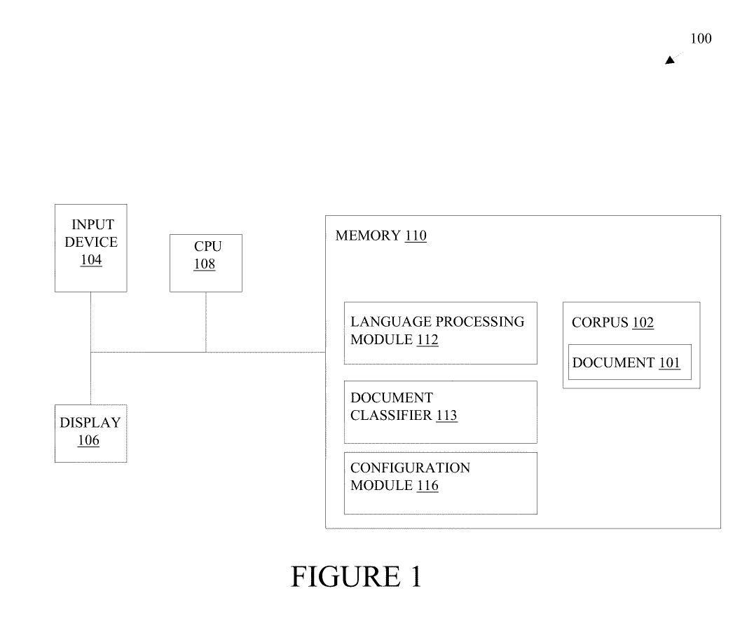

Referring to FIG. 1, an exemplary embodiment of a computing device 100 configured to classify a document 101 according to one or more embodiments of the invention is disclosed. The computing device 100 can be configured to generate one or more clusters from content associated with the document 101. Subsequently, one or more concepts are identified within the one or more clusters of the document 101. Further, the computing device 100 can be configured to utilize the one or more concepts identified within the document 101 to determine one or more categories for the document 101 for classification. In an embodiment, the computing device 100 can be configured to retrieve the document 101 from a corpus 102. Alternatively, a user of the computing device 100 provides the document 101.

In an embodiment, the computing device 100 can be configured to include an input device 104, a display 106, a central processing unit (CPU) 108 and memory 110 coupled to each other. The input device 104 can include a keyboard, a mouse, a touchpad, a trackball, a touch panel or any other form of the input device 104 through which the user can provide inputs to the computing device 100. The CPU 108 is preferably a commercially available, single chip microprocessor including such as a complex instruction set computer (CISC) chip, a reduced instruction set computer (RISC) and the like. The CPU 108 is coupled to the memory 110 by appropriate control and address busses, as is well known to those skilled in the art. The CPU 108 is further coupled to the input device 104 and the display 106 by bi-directional data bus to permit data transfers with peripheral devices.

The computing device 100 typically includes a variety of non-transitory computer-readable media. By way of example, and not limitation, the computer-readable media can comprise Random Access Memory (RAM), Read Only Memory (ROM), Electronically Erasable Programmable Read Only Memory (EEPROM), flash memory other memory technologies; CDROM, digital versatile disks (DVDs) or other optical or holographic media; magnetic cassettes, magnetic tape, magnetic disk storage or other magnetic storage devices; or any other medium that can be used to encode desired information and be accessed by computing device 100.

The memory 110 includes computer-storage media in the form of volatile and/or nonvolatile memory. The memory 110 may be removable, non-removable, or a combination thereof. In an embodiment, the memory 110 includes the corpus 102, and one or more language processing modules 112 such as to process the corpus 102 to retrieve the document 101, and a document classifier 113 configured to classify the document 101. The corpus 102 can include text related information including tweets, Facebook postings, emails, claims reports, resumes, operational notes, published documents or combination of any of these texts. In an embodiment, the text related information of the corpus 102 can be utilized to build the document 101 so that the document classifier 113 can be configured to classify the document 101. In an embodiment, the corpus 102 can be configured to include one or more documents of respective domains. Subsequently, the user of the computing device 100 inputs a request comprising a request to classify a particular document from a particular domain. Subsequently, the particular document can be extracted from the corpus 102 and classified thereafter.

The one or more language processing modules 112 can be configured to process structured or unstructured text of the document 101 at a sentence level, clause level or at phrase level. The language processing modules 112 can further be configured to determine which noun-phrases refer to which other noun-phrases. Accordingly, one or more co-referential sentences or clauses can be determined. Based on the one or more co-referential sentences or clauses, clusters are generated at clause level or at sentence level. For example, a clause cluster can indicate presence of co-referential clauses of the document 101. Similarly, a sentence cluster can indicate presence of co-referential sentences of the document 101.

In an embodiment, the document classifier 113 can be configured to identify one or more concepts within each cluster of the document 101. For example, the document classifier 113 can be configured to identify the one or more concepts within each clause of the clause cluster or the sentence cluster of the document 101. Subsequently, the document classifier 113 can be configured to determine one or more representative concepts for each cluster of the document 101 such that the one or more representative concepts can represent the content of the respective cluster. Further, the document classifier 113 can be configured to determine one or more categories for the document 101 such that the one or more categories of the document 101 are derived from the one or more representative concepts of the clusters identified in the document 101. Accordingly, the document classifier 113 can be configured to classify the document 101 into the one or more categories.

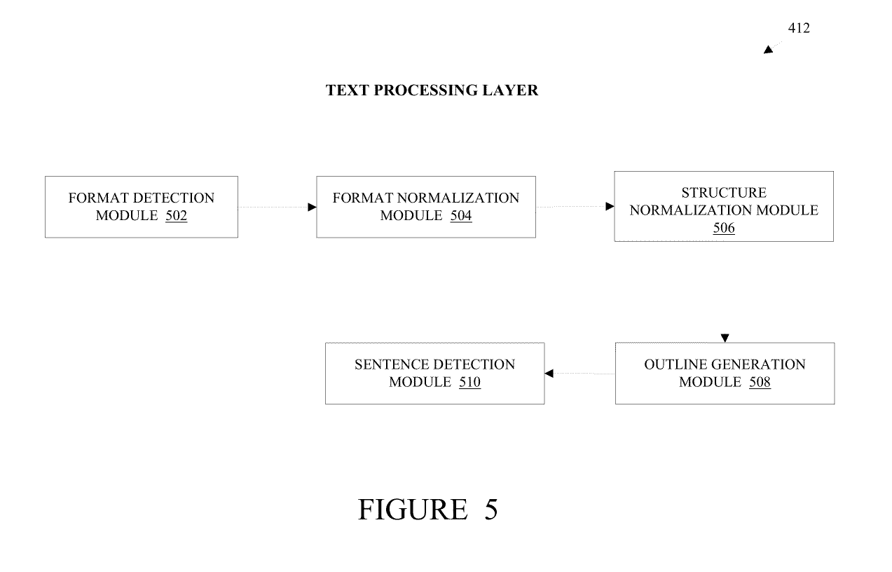

In an embodiment, the memory 110 can be configured to include a configuration module 116 so as to enable the user to input one or more configuration related parameters to control the processing of the language processing modules 112 and the classification of the document 101. In an embodiment, the user may input the parameters in a form of feedback. Accordingly, the computing device 100 can utilize this feedback so as to control the classification of the document 101. For example, the user may indicate using the configuration module 116 a selection of classification rules that can be used for classifying the document 101. In an embodiment, the user can manage the classification rules using the configuration module 116. For example, the user can update a particular classification rule by modifying respective definitions of the particular classification rule. Further, the user can add or remove a specific classification rule and respective definition of the specific classification rule. Subsequently, the document classifier 113 can be configured to access the configuration module 116 so as to classify the document 101 using the user selected rules. The methods and systems described herein discloses a model based approach wherein the configuration module 116 can be used to control the classification of the document 101 and is further described in detail in FIG. 5 of this disclosure.

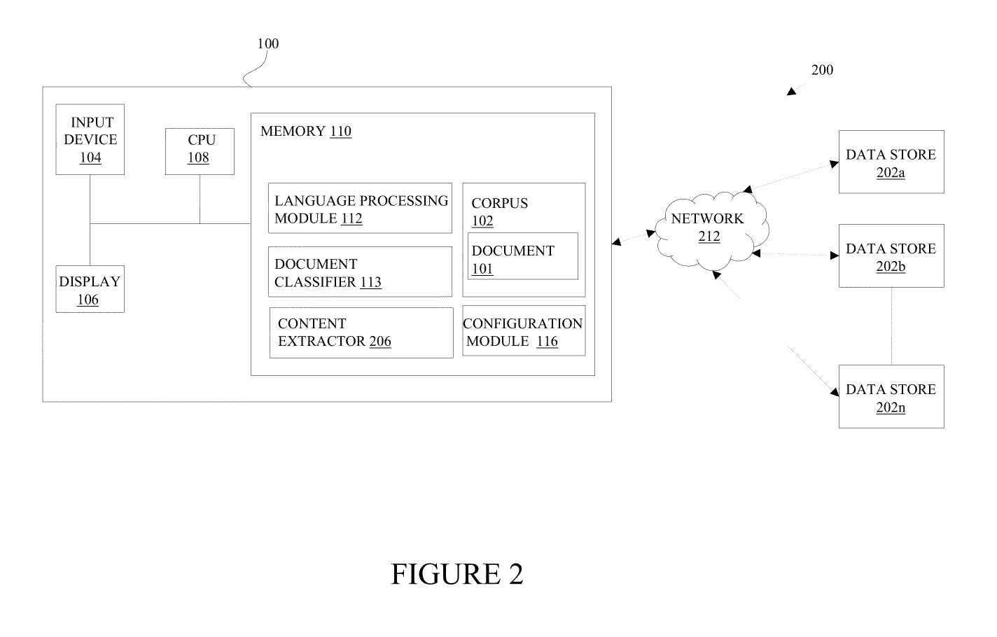

FIG. 2 illustrates an exemplary embodiment of a computing environment 200 for classifying the document 101 extracted from the corpus 102 according to one or more embodiments of the invention. The computing device 100 can be configured to communicatively coupled to a plurality of data stores such as a data store 202a, data store 202b and a data store 202n (collectively referred herein to as the data store 202) through a network 212. The network 212 can be a wire-line network or wireless network configured to enable the computing device 100 to communicate with the data store 202 so as to extract content stored therein. In an example, the memory 110 can be configured to include a content extractor 206 to identify content that is required to be extracted from the data store 202.

In an embodiment, the user of the computing device 100 can input a specific request including a request to identify documents corresponding to a specific domain. The request may further include one or more search terms for which a search may be carried out within the data store 202 to identify the documents related to the one or more search terms. Accordingly, the content extractor 206 can be configured to extract documents from the data store 202 corresponding to the specific request of the user. For example, the content extractor 206 can extract various documents, manuals or any other textual information corresponding to one or more search terms. Each of the extracted documents is processed using the language processing modules 112 to identify clusters within the extracted document. Subsequently, the document classifier 113 can be configured to classify the extracted document into the one or more categories enabling the user to classify the extracted document.

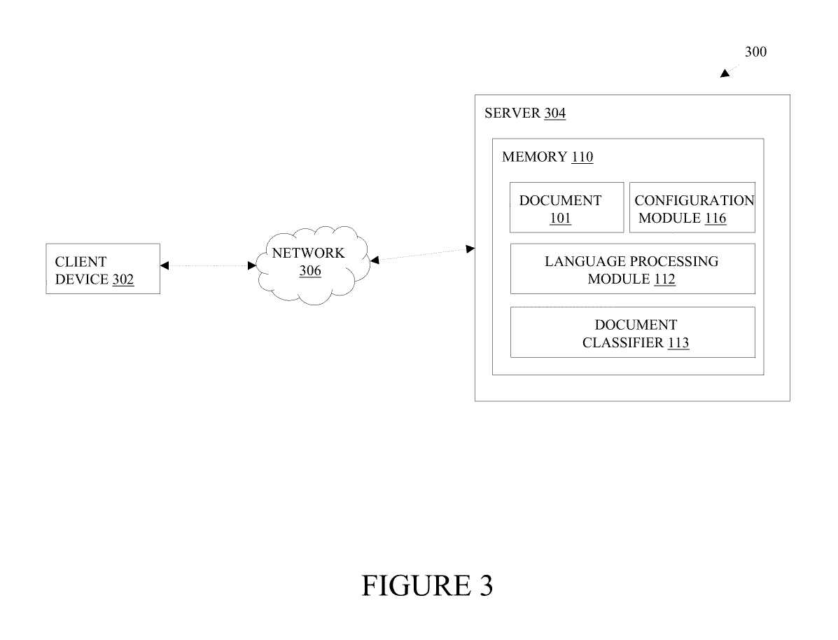

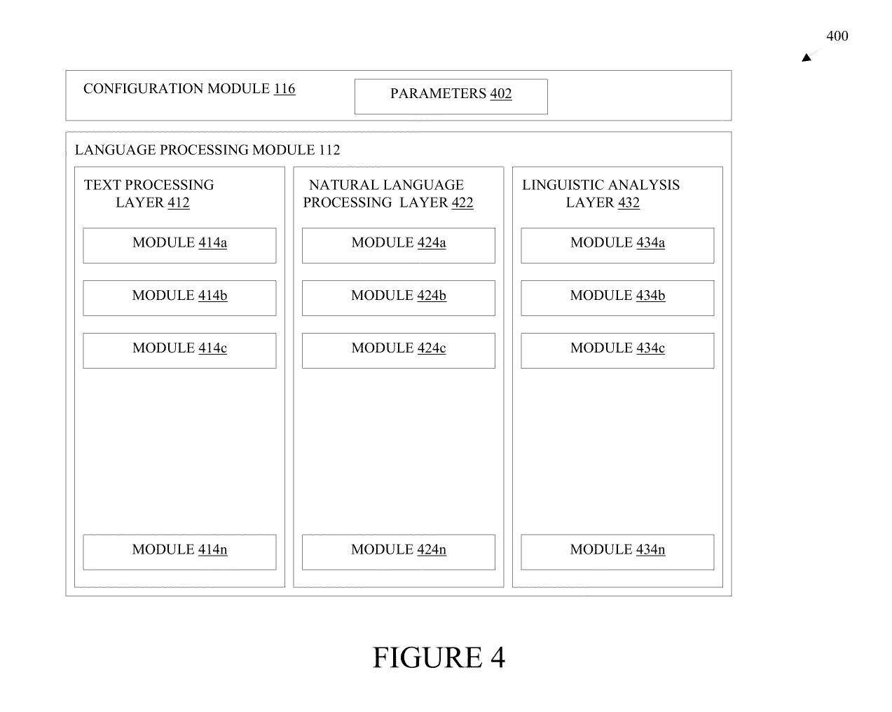

FIG. 3 illustrates an exemplary embodiment of a client server computing environment 300 for classifying the document according to one or more embodiments of the invention. The client server computing environment 300 includes a client device 302 configured to access a server 304 through a network 306. The client device 302 enables the user to input the specific document which requires to be classified. The client device 302 can include a personal computer, laptop computer, handheld computer, personal digital assistant (PDA), mobile telephone, or any other computing terminal that enable the user to transmit the request to classify the document 101 to the server 304. On receiving the request, the server 304 can be configured to process the document 101 using the language processing modules 112 and execute the document classifier 113 to classify the document 101 in to one or more categories. Accordingly, the one or more categories for the document 101 are transmitted back to the client device 302. Consequently, the client device 302 may display the results of the classification (i.e., the one or more categories) to the user in a manner as illustrated in FIG. 4 of this disclosure. Further, the client device 302 can communicate feedback from the user to the server 304 in the configuration module 116 such that the server 304 can be configured to control the classification of the document 101 using the configuration module 116.

FIG. 4 illustrates an exemplary embodiment of a block diagram 400 depicting the processing of the document 101 in the corpus 102 using the language processing modules 112 according to one or more embodiments of the invention. As shown, parameters 402 of the configuration module 116 can be accessed to control the execution of the language processing modules 112. In an embodiment, the language processing modules 112 can be configured to include one or more processing layers such as a text processing layer 412, a natural language processing layer 422 and a linguistic analysis layer 432. The text processing layer 412 can be configured to include one or more modules such as a module 414a, a module 414b, a module 414c and a module 414n such as to execute text level processing of the document 101 identified in the corpus 102. The natural language processing layer 422 can be configured to include one or more modules such as a module 424a, a module 424b, a module 424c and a module 424n so as to derive meaning from the natural language as depicted in the processed text of the document 101. The linguistic analysis layer 432 can be configured to include one or more modules such as a module 434a, a module 434b, a module 434c and a module 434n such as to determine clusters within the document 101.

In an embodiment, the one or more modules of the various layers can be configured to include one or more respective rules for performing one or more operations on the text in the document 101. For example, the module 414 includes respective rules that are used to perform text related processing in the text processing layer 412. Similarly, the module 434 includes respective rules that are used to determine one or more clusters in the document 101. The methods and systems described herein allow the user to manage the rules corresponding to the respective modules using the configuration module 116. In an embodiment, the user can modify such rules via parameters 402 of the configuration module 116. For example, the user can add or remove any rules for the respective modules via the parameters 402 of the configuration module configuration module 116. As a result, the methods and systems described herein enable the user to control the execution of the language processing modules 112 and thereby provide flexibility of incorporation of feedback from the user.

FIG. 5 illustrates an exemplary embodiment of a block diagram for the text processing layer 412 according to one or more embodiments of the invention. The text processing layer 412 can be configured to include one or more modules such as a format detection module 502, a format normalization module 504, a structure normalization module 506, an outline generation module 508 and a sentence detection module 510. In one embodiment, the format detection module 502 can be configured to identify the format of the document 101. In one embodiment, the document 101 can be accessed from one or more sources such as the corpus 102 or the data store 202. In an example, the document 101 can be accessed based on the input from the user or through a batch processing system. Alternatively, the user can input the document 101. In one embodiment, the format detection module 502 can be configured to detect the format of the document 101 using format detection techniques employing one or more algorithms such as byte listening algorithm, source-format mapping algorithm or other algorithms.

Subsequently, the format detection module 502 detects the format of the document 101. The detected format can include one or more image or textual formats such as HTML, XML, XLSX, DOCX, TXT, JPEG, TIFF, or other document 101 formats. Further, the format normalization module 504 can be configured to process the document 101 into a normalized format. In addition, the format normalization module 604 can be configured to implement one or more text recognition techniques such as an optical recognition technique (OCR) to detect text within the document 101 when the format of the document 101 is an image format or one or more images are embedded within the document 101. In one embodiment, the normalized format of the document 101 can include a format including but not limited to a portable document format, an open office xml format, html format and text format.

In one embodiment, the structure normalization module 506 can be configured to convert the data in the document 101 into a list of paragraphs and other properties (e.g., visual properties such as font-style, physical location on the page, font-size, centered or not, and the like) of the document 101. Subsequently, the outline generation module 508 can be configured to process the one or more paragraphs of the document 101. For example, the outline generation module 508 can be configured to convert the one or more paragraphs using one or more heuristic rules into a hierarchical representation (e.g., sections, sub-sections, tables, graphics, and the like) of the document 101. In addition, the outline generation module 508 can be configured to remove header and footer within the document 101 so as to generate a natural outline for the given document 101.

Subsequently, the sentence detection module 510 can be configured to perform sentence boundary disambiguation techniques so as to detect sentences within the each textual paragraph of the document 101. In addition, the sentence detection module 510 can be configured to handle detection of parallel sentences where a sentence is continued in several lists and sub-lists.

In an embodiment, the user can alter such rules for varying the output from the modules of the text processing layer 412 using the parameters 402 of the configuration module parameters 116. For example, the user can specify a domain such as a legal domain using the parameters 402 and accordingly, the outline generation module 508 can be configured to utilize rules associated with the legal domain for generating the hierarchical representation of the document 101. Further, the user can provide input using the parameters 402 such as to handle OCR errors using the outline generation module 508. In another example, the user can modify the rules for the sentence detection module 510 so as to add or delete rules for detecting sentences within the paragraph of the document 101. In another example, the user can utilize the parameters 402 so as to modify sentence detection based rules. In another embodiment, the user can enable or disable the execution of any of the modules of the text processing layer 412.

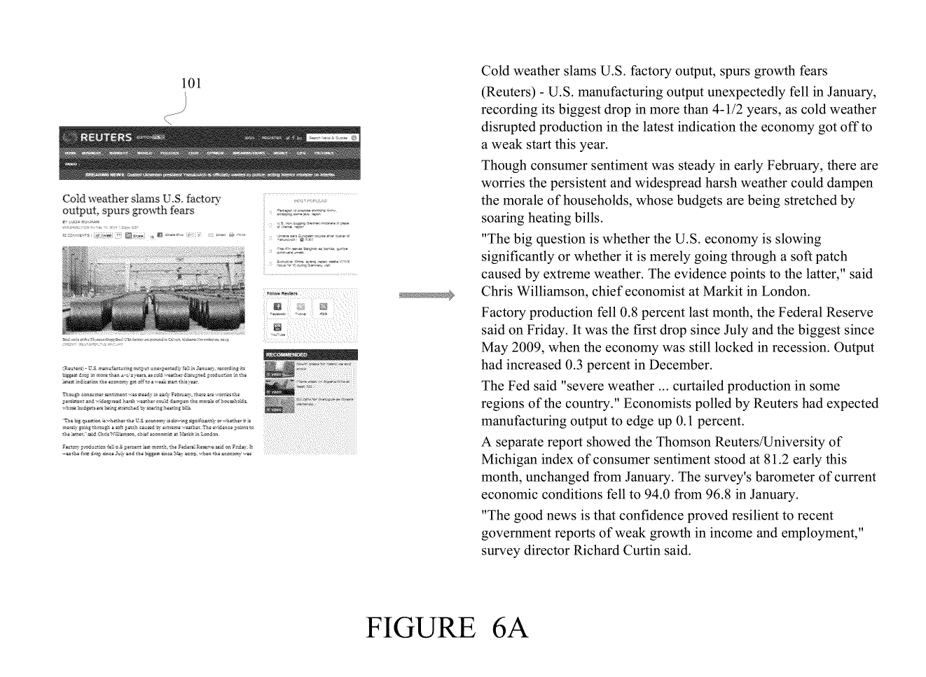

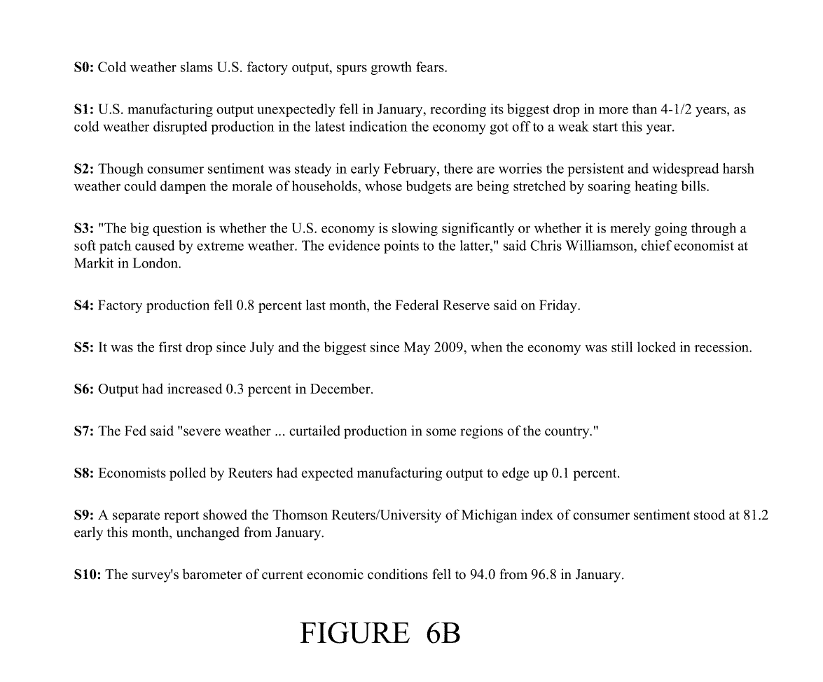

Referring to FIG. 6A, an exemplary unstructured document 101 is accessed for processing according to one or more embodiments of the invention. The unstructured document 101 can be extracted from the corpus 102 or from the external data store 202. In an embodiment, the text processing layer 412 can be configured to execute the aforementioned modules on the document 101 so as to extract text related information from the unstructured document 101. As illustrated, the various modules of the text processing layer 412 extract the textual information from the unstructured document. In addition, the sentence detection module 510 can be configured to detect one or more sentences within the extracted text of the unstructured document 101. As illustrated in FIG. 6B, the sentence detection module 510 extracts ten different sentences from the unstructured document 101. Each sentence of the unstructured document 101 is labeled as S0-S10.

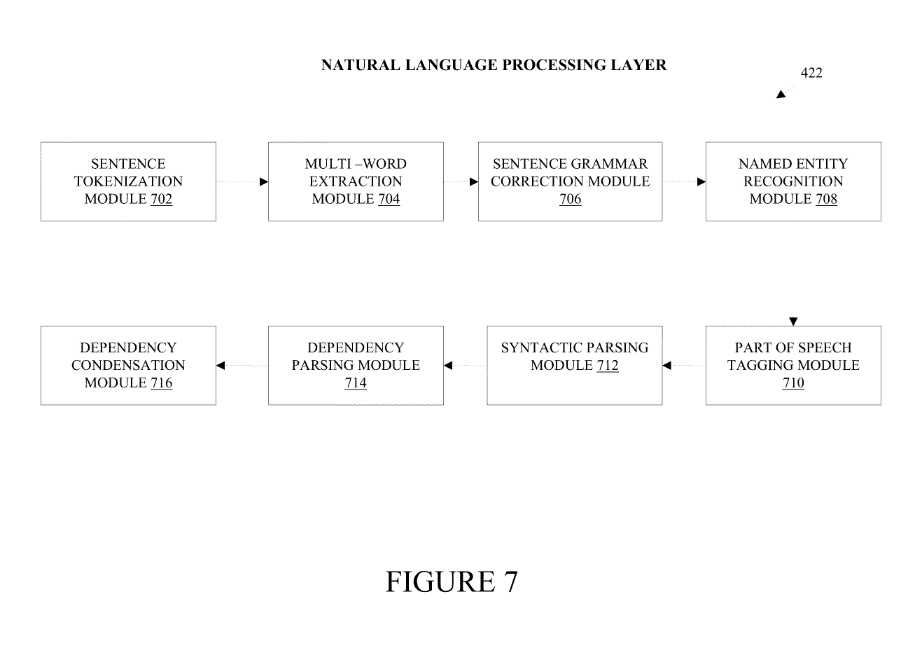

FIG. 7 illustrates an exemplary embodiment of a block diagram for the natural language processing layer 422 according to one or more embodiments of the invention. In one embodiment, the natural language processing layer 422 includes various modules that are configured to determine syntax related processing of the sentences (e.g., S0-S10 of FIG. 6). In one embodiment, the natural language processing layer 422 can be configured to include a sentence tokenization module 702, a multi-word extraction module 704, a sentence grammar correction module 706, a named-entity recognition module 708, a part-of-speech tagging module 710, a syntactic parsing module 712, a dependency parsing module 714, and a dependency condensation module 716.

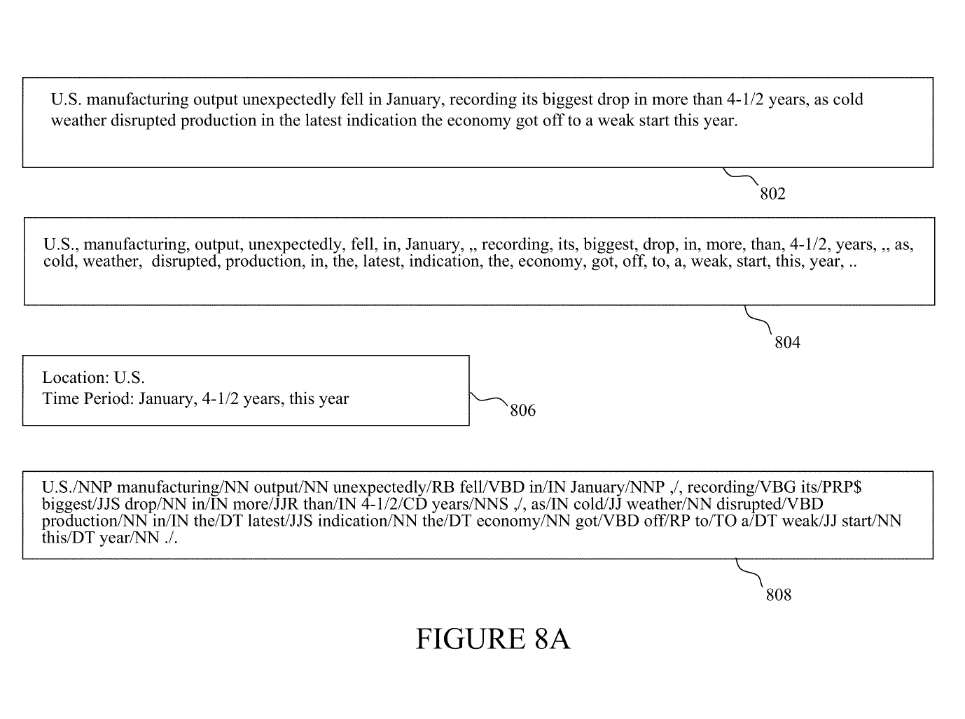

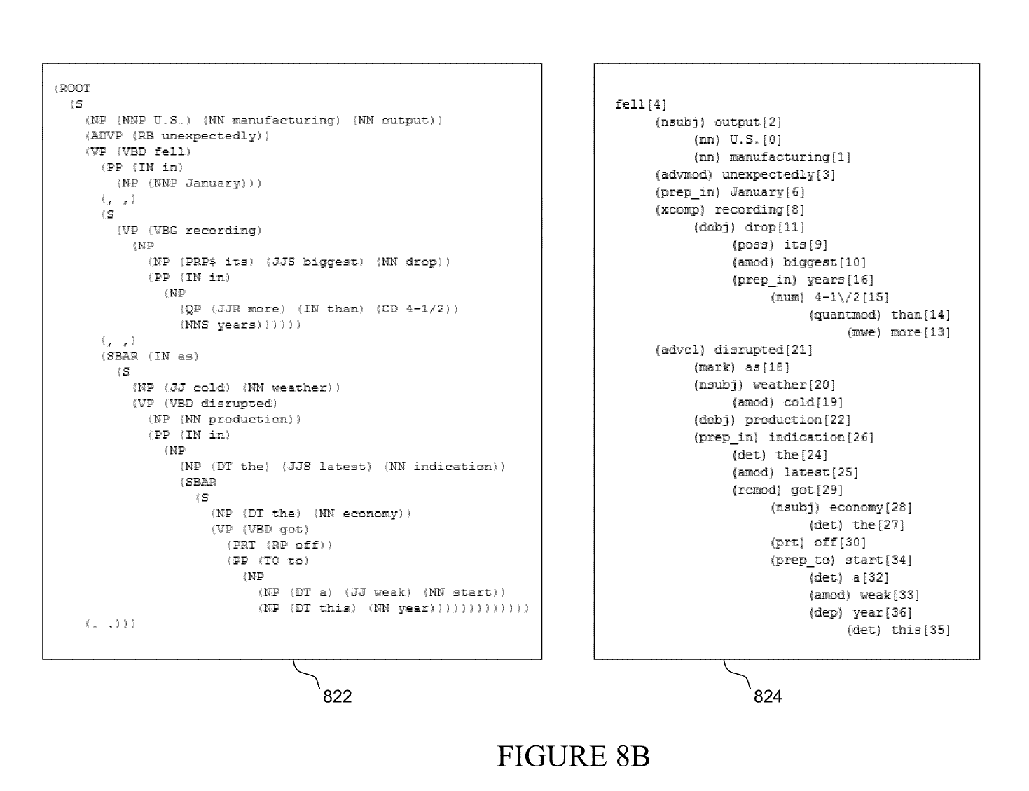

The sentence tokenization module 702 can be configured to segment the sentences into words. Specifically, the sentence tokenization module 702 identifies individual words and assigns a token to each word of the sentence. The sentence tokenization module 702 can further include expanding contractions, correcting common misspellings and removing hyphens that are merely included to split a word at the end of a line. In an embodiment, not only words are considered as tokens, but also numbers, punctuation marks, parentheses and quotation marks. The sentence tokenization module 702 can be configured to execute a tokenization algorithm, which can be augmented with a dictionary-lookup algorithm for performing word tokenization. For example, the sentence tokenization module 702 can be configured to tokenize a sentence as indicated in block 802 of FIG. 8A. Accordingly, an output of the sentence tokenization module 702 for the sentence in the block 802 is illustrated in a block 804. The block 804 depicts each word is segmented using a punctuation (,) for assigning a token.

The multi-word extraction module 704 performs multi-word matching. In an embodiment, for all words that are not articles, such as “the” or “a”, consecutive words may be matched against a dictionary to learn if any matches can be found. If a match is found, the tokens for each of the words can be replaced by a token for the multiple words. In an example, the multi-word extraction module 704 can be configured to execute a multi-word extraction algorithm that can be augmented with a dictionary-lookup algorithm for performing multi-word matching. This is useful but not a necessary step and if the domain of the document 101 from which the sentences are extracted is known, this step can help in better interpretation of certain domain-specific application. For example, if the sentence of the block 802 is subjected to the multi-word extraction module 804, the words like ‘manufacturing output’ and ‘production’ may be identified as matched words and can be assigned a token for the multiple words.

The sentence grammar correction module 706 can be configured to perform text editing functions to provide complete predicate structures of sentences that contain subject and object relationships. The sentence grammar correction module 706 is configured to perform the correction of words, phrases or even sentences which are correctly spelled but misused in the context of grammar. In an example, the sentence grammar correction module 706 can be configured to execute a grammar correction algorithm to perform text editing functions. The grammar correction algorithm can be configured to perform at least one of punctuation, verb inflection, single/plural, article and preposition related correction functionalities. For example, if the sentence of the block 802 is subjected to the sentence grammar correction module sentence grammar correction module 706, the sentence 802 may not undergo any changes as the said sentence 802 does not include any grammatical error. However, the sentence grammar correction module 706 can correct any grammatically incorrect sentence subjected thereto.

The named-entity recognition module 708 can be configured to generate named entity classes based on occurrences of named entities in the sentences. For example, the named-entity recognition module 708 can be configured to identify and annotate named entities, such as names of persons, locations, or organizations. The named-entity recognition module 708 can label such named entities by entity type (for example, person, location, time-period or organization) based on the context in which the named entity appears. For example, the named-entity recognition module 708 can be configured to execute a named-entity recognition algorithm, which can be augmented with a dictionary-based named entity lists. This is useful but not a necessary step and if the domain of the document 101 (from which the sentences are extracted) is known, this step can help in better interpretation of certain domain-specific applications. In an example, if the sentence of the block 802 is subjected to the named-entity recognition module 708, the terms like U.S. and January or 4½ years or this year can be classified in the classes such as location and time period respectively. The output is illustrated in a block 806 of FIG. 8A.

The part-of-speech tagging module 710 can be configured to assign a part-of-speech tag or label to each word in a sequence of words. Since many words can have multiple parts of speech, the part-of-speech tagging module 710 must be able to determine the part of speech of a word based on the context of the word in the text. The part-of-speech tagging module 710 can be configured to include a part-of-speech disambiguation algorithm. An output as illustrated in block 808 can be obtained when the sentence in the block 802 is subjected to the part-of-speech tagging module 710. The output in the block 808 indicates the part-of-speech tags associated with every word of the sentence of the block 802.

The syntactic parsing module 712 can be configured to analyze the sentences into its constituents, resulting in a parse tree showing their syntactic relationship to each other, which may also contain semantic and other information. The syntactic parsing module 712 may include a syntactic parser configured to perform parsing of the sentences. In an example, if the sentence of the block 802 is subjected to the syntactic parsing module 712, the sentence of the block 802 can be parsed to show the syntactic relationship as shown in a block 822 of FIG. 8B.

The dependency parsing module 714 can be configured to uniformly present sentence relationships as a typed dependency representation. The typed dependencies representation is designed to provide a simple description of the grammatical relationships in a sentence. In an embodiment, every sentence's parse-tree is subjected to dependency parsing. A block 824 of FIG. 8B illustrates an exemplary embodiment of an output of the dependency parsing module 714 when the parse tree of the sentence of block 802 is subjected to the dependency parsing module 714.

In one embodiment, the dependency condensation module 716 can be configured to condense the dependency tree (e.g., the block 824 of the FIG. 8B) so as to club phrases and attributes together. In an example, the dependency tree includes dependencies amongst the tokens of the sentence and the condensed dependency tree (the includes dependencies between phrases (e.g., noun phrases, verb phrases, prepositional phrases and the like) after removing some tokens that exhibit other semantics with the phrases (e.g., attributes such as time-period, quantity, location, and the like). The condensed dependency tree aids in identifying relationship between the phrases.

In an embodiment, the methods and systems described herein enable the user to control the processing of the various modules of the natural language processing layer 422 using the parameters 402 of the configuration module 116. For example, the user can input in the form of the parameters 402 domains for the processing of the modules of the natural language processing layer 422. A legal domain input can restrict the processing of the modules in accordance with rules defined for the legal domain. The user can input multi-word extraction list so as to configure the multi-word extraction module 704 to extract the multi-words using the extraction list as input by the user. Similarly, the user can input list of named entities so as to configure the named entity recognition module 708 to consider the user input while identifying and annotating the named entities.

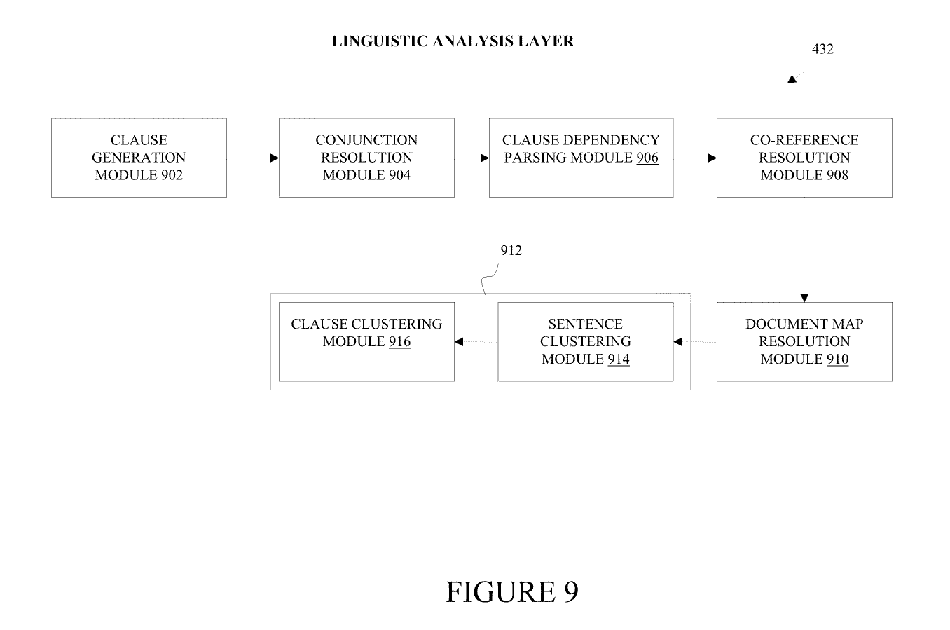

FIG. 9 illustrates an exemplary embodiment of a block diagram for the linguistic analysis layer 432 according to one or more embodiments of the invention. The linguistic analysis layer 432 can be configured to include various modules that are configured to identify clauses and phrases or concepts in the sentences and the correlation there-between. In one embodiment, the linguistic analysis layer 432 includes a clause generation module 902, a conjunction resolution module 904, a clause dependency parsing module 906, a co-reference resolution module 908, a document map resolution module 910, a clustering module 912 including a sentence clustering module 914 and a clause clustering module 916, and a representative concepts identification module 918.

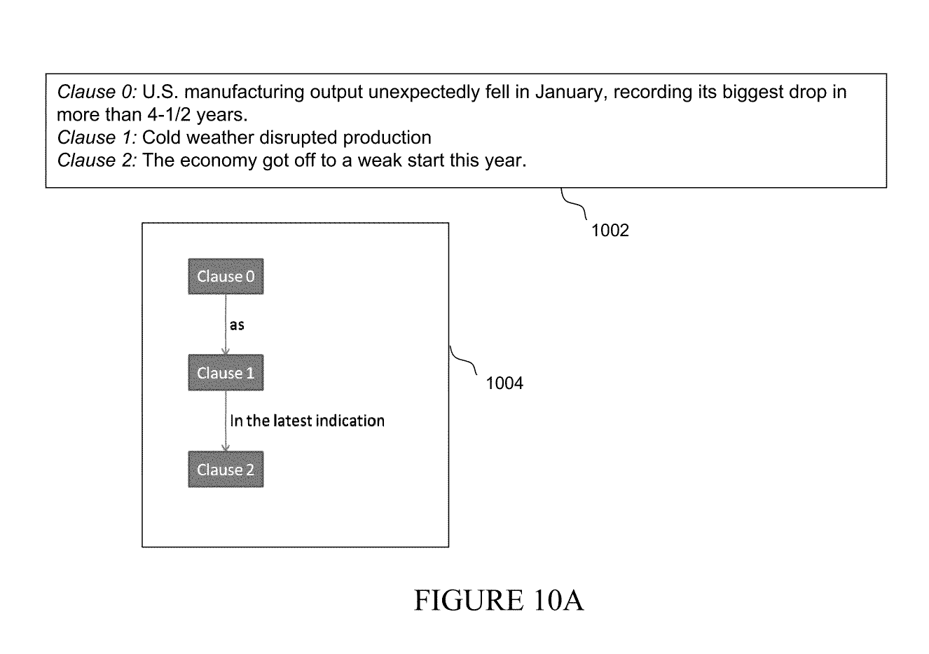

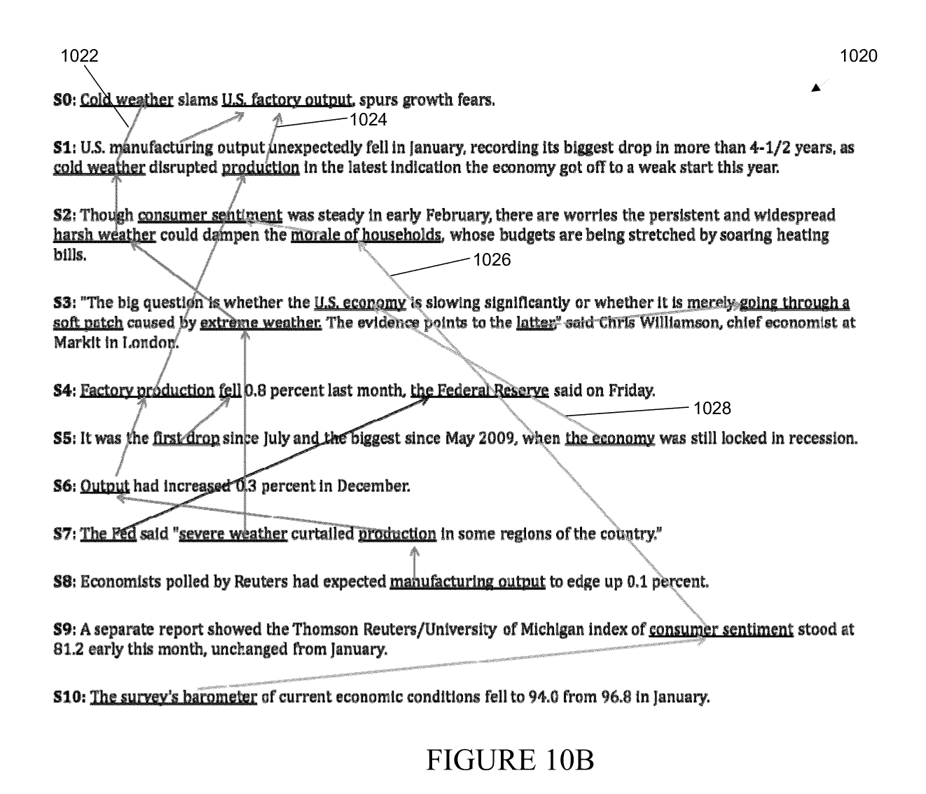

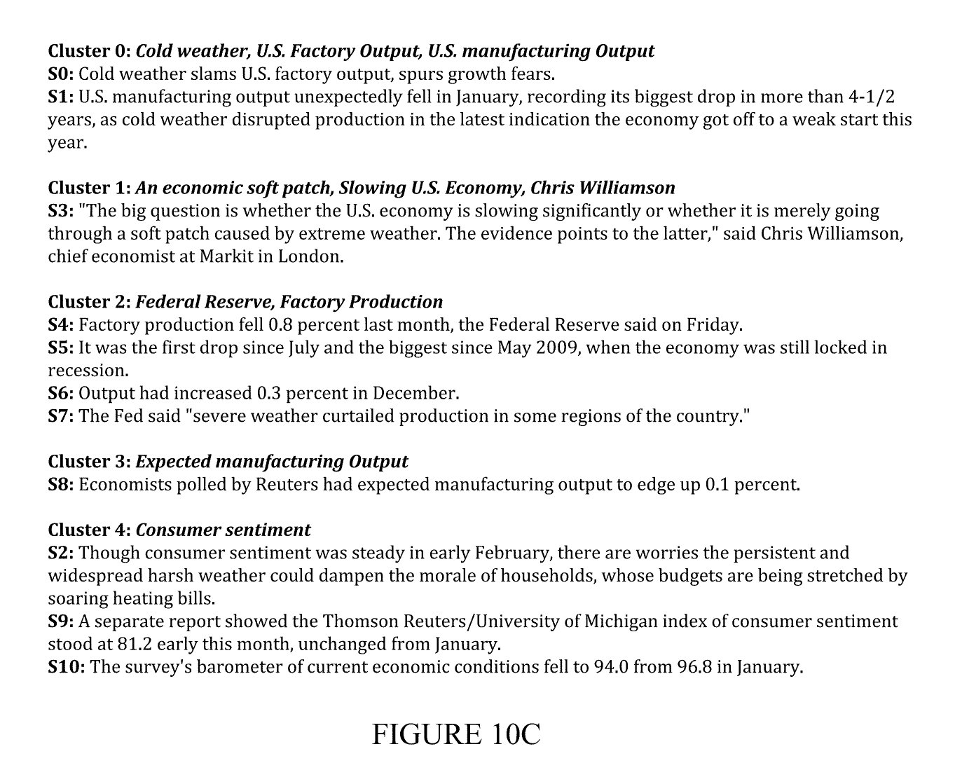

The clause generation module 902 can be configured to generate meaningful clauses from the sentences. For example, a complex sentence can include various meaningful clauses, and the task of the clause generation module 902 is to break a sentence into several clauses such that each linguistic clause is an independent unit of information. The clause can also be referred to as a single discourse unit (SDU), which is the independent unit of information. The clause generation module 902 includes a clause detection algorithm, configured to execute clause boundary detection rules and clause generation rules, for generating the clauses from the sentences. In an example, if the sentence 802 (as shown in FIG. 8A) is subjected to the clause generation module 902, the sentence of the block 802 is segregated into several clauses, which is depicted in a block 1002 in FIG. 10A. The block 1002 depicts that the sentence of the block 802 is segregated into three clauses, i.e., Clause 0, Clause 1 and Clause 2.

The conjunction resolution module 904 can be configured to separate sentences with conjunctions into its constituent concepts. For example, if the sentence is “Elephants are found in Asia and Africa”, the conjunction resolution module 904 split the sentence into two different sub-sentences. The first sub-sentence is “Elephants are found in Asia” and the second sub-sentence is “Elephants are found in Africa”. The conjunction resolution module 904 can process complex concepts so as to aid normalization.

The clause dependency parsing module 906 can be configured to parse clauses to generate a clause dependency tree. In an embodiment, the clause dependency parsing module 906 can be configured to include a dependency parser that is configured to perform the dependency parsing to generate the clause dependency tree. The clause dependency tree can indicate the dependency relationship between the several clauses. In an example, if the sentence of the block 802 is subjected to the clause dependency parsing module 906, a clause dependency tree can be generated for the various clauses (i.e., Clause 0, Clause 1 and Clause 2) so as to determine dependency relations. An exemplary embodiment of a clause dependency tree is in a block 1004 of FIG. 10A.

The co-reference resolution module 908 can be configured to identify co-reference relationship between noun phrases of the several clauses. The co-reference resolution module 908 finds out which noun-phrases refer to which other noun-phrases in the several clauses. The co-reference resolution module 908 can be configured to include a co-reference resolution algorithm configured to execute co-reference detection rules and/or semantic equivalence rules for finding co-reference between the noun phrases. In an embodiment, the co-reference resolution module 908 can be configured to implement one or more feature functions so as to identify semantic similarities between the noun phrases of the several clauses or sentences of the document 101. For example, assuming F as a set of feature functions, the co-reference resolution module 908 can be configured to consider two noun phrases as arguments Xᵢ and Xⱼ of the respective sentences of the document 101. The argument Xᵢ indicates a noun phrase at an index i and the argument Xⱼ indicates a noun phrase at an index j of a sentence or clause of the document 101. Depending on the values of the indexes i and j, a binary valued function such as a binary anaphoric function or a binary cataphoric function can be executed. For example, if the index i is greater than the index j, the binary cataphoric function is executed otherwise, the binary anaphoric function is executed.

The binary valued function generates two binary outputs namely as true and a false. For example, a true output from the binary anaphoric function indicates that the noun phrase at the index i is an anaphora of the noun phrase at the index j. Further, a false output from the binary anaphoric function indicates that the noun phrase at the index i is not an anaphora of the noun phrase at the index j. Similarly, a true output from the binary cataphoric function indicates that the noun phrase at the index j is a cataphora of the noun phrase at the index i. Further, a false output from the binary cataphoric function indicates that the noun phrase at the index j is not an anaphora of the noun phrase at the index i. Accordingly, based on the output of these anaphoric and cataphoric functions, the co-reference resolution module 908 can be configured to determine anaphoric and cataphoric co-referential relationships the noun phrases of the document 101.

In addition, the co-reference resolution module 908 can be configured to add or remove the one or more feature functions. In an example, the user may add or remove the one or more feature functions using the parameters 402 of the configuration module 116. The one or more feature functions can be added or removed according to domain and language of the document 101.

Additionally, the co-reference resolution module 908 can be configured to assign a score to every co-reference relationship based on the type of the co-reference. The co-reference resolution module 908 may include a co-reference relationship scoring algorithm configured to score every co-reference relationship based on the type of co-reference. In an embodiment, the score for the co-reference relationship can be derived using weights assigned to the feature functions. For example, W can be the weight function giving static (or learned) weights to each of the functions in F. Specifically, W is a vector containing w₀, w₁, and wₖ, where wᵢ is the weight for the function fᵢ such that,

$${\sum }_{0}^{K} {w}_{k} = 100$$

The wₖ can either be determined using a supervised algorithm using graphical models (on a data-set) or can be defined empirically. Accordingly, the co-reference resolution module 908 can be configured to determine strength of the semantic similarities between the two sentences or the clauses of the document 101. For example, the strength of semantic similarity between a sentence Sa (with M noun-phrases) and a sentence Sb (with N noun-phrases) in the document 101 can be represented by S (a, b)

$$S ( a , b ) = {\sum }_{i = 1}^{M} {\sum }_{j = 0}^{N} {\sum }_{k = 0}^{K} {w}_{k} \cdot {f}_{k} ( {x}_{i} , {x}_{j} )$$

Similarly, the strength of semantic similarity between a clause Ca (with P noun-phrases) and a clause Cb (with Q noun-phrases) in the document 101 can be represented by C (a, b)

$$C ( a , b ) = {\sum }_{i = 1}^{P} {\sum }_{j = 0}^{Q} {\sum }_{k = 0}^{K} {w}_{k} \cdot {f}_{k} ( {x}_{i} , {x}_{j} )$$

The document map resolution module 910 can be configured to generate a map based on an output of the co-reference resolution module 908, i.e., based on the identified co-reference relationships of the noun phrases. In an embodiment, the document map resolution module 910 can be configured to generate a document map similar to a map 1020 as illustrated in FIG. 10B. The map 1020 is a graph of sentences depicting various co-reference relationships to each other. In an example, if the sentences S0-S10 of FIG. 6B are subjected to the co-reference resolution module 908, the document map resolution module 910 generates the document map 1020 indicating various co-reference relationships identified between the noun phrases of the sentences S0-S10.

As shown, the collapsing multiple arrows, such as arrows 1022, 1024, 1026 or 1028, indicate co-reference relationships between the noun phrases of the every the sentences. Additionally, the document map 1020 may depict a score (not shown) based on the strength of co-reference relationship of the noun phrases. For example, every edge between two sentences holds the sum of co-reference scores between the noun-phrases of these two sentences.

Further, based on the co-reference relationship score, the clustering module 912 can be configured to create clusters of sentences or clauses. In an embodiment, the sentence clustering module 914 can be configured to cluster the sentences based on the co-reference relationship scores. As shown in FIG. 10C, the several clusters, namely cluster 0 through cluster 4, are formed based on the respective co-reference scores. For example, when the sentences of the document map 1020 are subjected to the sentence clustering module 914, the cluster 0 through cluster 4 are formed based on the co-reference relationship scores of the noun phrases of the sentences. Specifically, from the document-map 1020, some edges, with weights less than a threshold, are dropped and the resulting graph is a collection of sub-graphs where there are no edges between any two sub-graphs. Each of these sub-graphs is a contextual cluster. The context of a cluster may be identified based on the co-referential noun phrases. Moreover, the threshold that is determined is static and is found using empirical methods using linguistic rules.

In one embodiment, based on the co-reference relationship score clustering of clauses can also be achieved. The clause clustering module 1016 can be configured to cluster the clauses based on the co-reference relationship scores. A specific clause cluster can include one or more clauses that are contextually similar to each other. Further, the clause clustering module 916 can be configured to generate the clause clusters in a way such that a clause from a first cluster is not in context with another clause in a second cluster. As a result, the clause clusters as generated by the clause clustering module 916 can eliminate false positives.

In an embodiment, the methods and systems described herein enable the user to control the processing of the various modules of the linguistic analysis layer 432 using the parameters 402 of the configuration module 116. In an example, the user can input the clause generation related configuration parameters for the clause generation module 902 through the parameters 402 of the configuration module 116. Similarly, the user can modify rules for the conjunction resolution module 904 for example, by providing a resolution related input for the conjunction resolution module 904. In an example, the user can input dependency related inputs using the parameters 402 for the clause dependency parsing module 906. The methods and systems described herein enable the user to input the threshold value for the co-referential scores that can be used to modify the generation of clusters. Such control in the execution of the modules can enable the user to control the input for the ontology generation module 114.

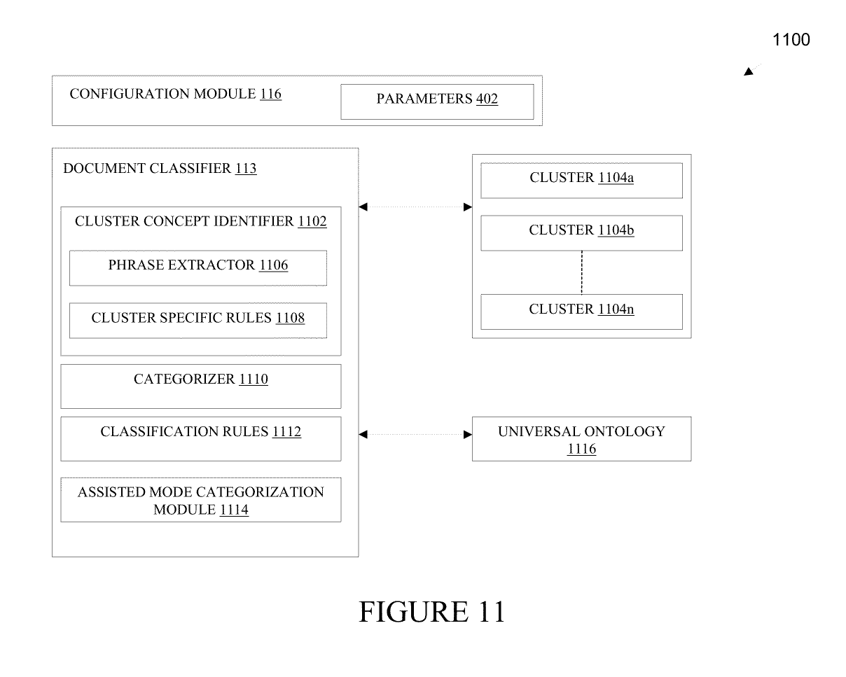

FIG. 11 illustrates an exemplary embodiment of a block diagram of the document classifier 113 configured to classify the document 101 according to one or more embodiments of the invention. The document classifier 113 can be configured to include a cluster concept identifier 1102 configured to identify one or more concepts from a plurality of clusters such as a cluster 1104a, a cluster 1104b, and a cluster 1104n (collectively referred herein to as a cluster 1104) determined from the document 101. In an embodiment, the cluster concept identifier 1102 can be configured to include a phrase extractor 1106 and one or more cluster specific rules 1108 to identify one or more representative concepts for the each cluster 1104 of the document 101. The respective representative concepts of the clusters 1104 represents the content corresponding to the respective clusters 1104.

In an embodiment, the phrase extractor 1106 can be configured to extract one or more noun phrases available within the cluster 1104a of the document 101. Further, the phrase extractor 1106 can be configured to determine variants of each of the one or more noun phrases identified in the cluster 1104a of the document 101. For example, the phrase extractor 1106 may determine a noun phrase such as a factory output in the cluster 1104a and other noun phrases such as factory production, output of the factory, production of the factory or other similar noun phrases as variants of the noun phrase “factory output”. The phrase extractor 1106 can be configured to generate a group of such similar noun phrases and determine a representative noun phrase of the group including the similar noun phrases. For example, the phrase extractor 1106 may determine the noun phrase “factory output” as the representative noun phrase of the aforementioned group including similar noun phrases related to the “factory output”. In an embodiment, the phrase extractor 1106 can be configured to determine a particular noun phrase as the representative noun phrase of the group of similar noun phrases such that the particular noun phrase have tokens which are present in all the noun phrases of the group. Further, the phrase extractor 1106 can be configured to identify the plurality of groups including similar noun phrases and the respective representative noun phrase for each group member of the plurality of groups.

In an embodiment, the cluster concept identifier 1102 can be configured to access the one or more cluster specific rules 1108 so as to determine the representative concept for the cluster 1102a of the document 101 using the plurality of groups including the similar noun phrases and representative noun phrases of these groups. In an example, the phrase extractor 1106 can be configured to determine count of the noun phrases found in each group member of the plurality of groups. The cluster specific rules 1108 can include information to select the representative noun phrase of a particular group as the representative concept of the cluster 1104a such that the particular group has the highest count of variants of noun phrases. In another example, the cluster specific rules 1108 can include information to consider the representative noun phrases of the plurality of groups as the representative concepts of the cluster 1104a such that the each group member of the plurality of groups includes a count of variants of noun phrases greater than a threshold count.

In an embodiment, the cluster specific rules 1108 can include information to assign a plurality of priority scores to the noun phrases identified within the cluster 1104a so that the phrase extractor 1106 can be configured to determine the one or more representative concepts for the cluster 1104a using the plurality of priority scores. In an example, a first priority score is assigned to the noun phrases when it is determined that a subject is identified within the noun phrase. Similarly, a second priority score is assigned to the noun phrase when one or more attributes of the document 101 are identified in the noun phrase. For example, phrase extractor 1106 assigns the second priority score to the noun phrase when at least a portion of the title of the document 101 is identified in the noun phrase. Subsequently, the phrase extractor 1106 can be configured to compute the first and second priority scores of the noun phrase and generate a list of the noun phrases ranked in accordance with the priority scores. Further, the phrase extractor 1106 can be configured to access the cluster specific rules 1108 to select top listed noun phrases as the representative concepts of the cluster 1104a.

The representative concept of the cluster 1104a indicates noun phrases that can have more linguistic importance than other noun-phrases of the cluster 1104a. Similarly, the cluster concept identifier 1102 can be configured to identify one or more representative concepts for each of the other clusters such as the cluster 1104b and the cluster 1104n of the document 101.

In an embodiment, one or more categories for the document 101 are identified using the one or more representative concepts of the clusters 1104 and the classification rules 1112. For example, a categorizer 1110 can be configured to access at least one rule from the classification rules 1112 so as to determine the one or more categories of the document 101.

In an embodiment, the classification rules 1112 can include information to determine a primary cluster from the one or more clusters 1104 of the document 101 and determine the one or more categories of the document 101 using the representative concept of the primary cluster of the document 101. The classification rules 1112 can further include various rules to determine the primary cluster of the document 101. For example, the specific cluster can be considered as the primary cluster when a title of the document 101 is determined within the specific cluster. In another example, the specific cluster can be considered as the primary cluster if a maximum numbers of sentences are identified in the specific cluster. In a yet another example, the specific cluster can be considered as the primary cluster if the specific cluster spans across the maximum number of sentences of the document 101.

In an embodiment, the classification rules 1112 can include information to assign a score to each representative concept of the each cluster and the categorizer 1110 can be configured to determine the one or more categories of the document 101 by selecting only those representative concepts of the clusters which have scores greater than a threshold score value. Accordingly, the document classifier 113 classifies the document 101 into the one or more categories that are derived from the representative concepts of the clusters which have scores greater than a threshold score value.

In an embodiment, the classification rules 1112 can include information to determine the strength of cluster from the strength of the relationships between the sentences of the cluster. Accordingly, the cluster having the maximum strength among the plurality of clusters is determined. The classification rules 1112 can include information to consider the representative concepts of the cluster having the maximum strength to derive the one or more categories for the document 101.

In an embodiment, the document classifier 113 can be configured to identify additional categories for the document 101 using an assisted mode categorization module 1114. The assisted mode categorization module 1114 enables the document classifier 113 to consider categories for the document 101 which may be predefined and delivered to the document classifier 113 in the form of the parameters 402 of the configuration module 116. For example, keywords for the categories may be extracted from sources outside the document 101 (e.g., from universal ontology 1116) and the document classifier 113 can be configured to determine whether the document 101 can be classified in the categories extracted from such outside sources.

In an embodiment, the assisted mode categorization module 1114 can be configured to receive the keywords for the categories from the universal ontology 1116 or from the user. For example, the user may desire to examine that whether the document 101 can be classified into a category “cloud computing”. Such keywords may be provided either automatically or manually through the parameters 502 of the configuration module 116. Accordingly, the document classifier 113 can be configured to determine contextual strength of the provided categories with respect to content of the clusters of the document 101 using the assisted mode categorization module 1114.

In an embodiment, the assisted mode categorization module 1114 can be configured to ascertain the contextual strength of the keywords and the content of the cluster if the keyword is contextually relevant to the content of the cluster. Further, the assisted mode categorization module 1114 can be configured to determine one or more levels of contextual relevancy such as a compound concept context relevancy, a subject verb object (SVO) context relevancy, same clause context relevancy, same sentence context relevancy, medium context relevancy (e.g., consecutive N clauses in the cluster), loose context relevancy (e.g., anywhere in the cluster), global loose context relevancy (e.g., anywhere in the document) or any combinations thereof to validate that the document 101 can be classified into the categories as provided from the sources outside the document 101. In addition, the assisted mode categorization module 1114 can be configured to categorize the document 101 at multiple levels. For example, using keywords from multiple ontologies, the assisted mode categorization module 1114 can categorize a specific document into the multiple levels of categories such as type of industry, originating place of the document, presence of certain concepts in the document and the like.

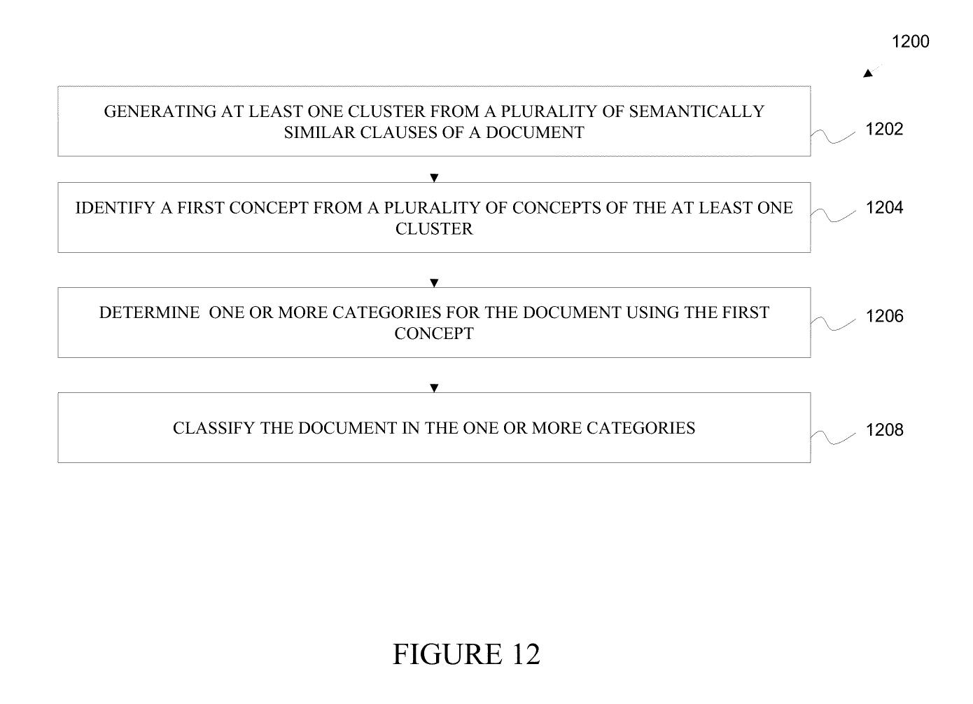

FIG. 12 illustrates an exemplary embodiment of a method for classifying a document in accordance with one or more embodiments of the invention. The method 1200 initiates at step 1202 wherein one or more clusters are generated from a plurality of semantically similar clauses of the document. In an embodiment, the plurality of semantically similar clauses can have one or more relationships such as co-referential relationships, conceptual relationships, and ontological relationships. Based on the strength of these relationships between the two clauses of the document, the cluster can be generated. For example, the cluster can include one or more pairs of clauses such that the strength of the relationships between the pairs of clauses is greater than a threshold strength value. The cluster can include one or more semantically similar clauses or sentences of the document.

At step 1204, the method 1200 can be configured to identify a first concept from a plurality of concepts of the cluster such that the first concept represents content of the cluster. In an embodiment, one or more groups of similar noun phrases are identified within the cluster and each noun phrase in a specific group is a variant of other noun phrases of the specific group. Further, a representative noun phrase for each group of similar noun phrases is determined. In an embodiment, representative noun phrases of the respective groups are ranked in accordance with cluster specific rules so as to determine the first concept from the representative noun phrase.

At step 1206, the method 1200 can be configured to determine at least one category for the document using the first concept of the at least one cluster. In an embodiment, one or more classification rules can be accessed to determine the one or more categories for the document. For example, the one or more classification rules can include information to determine a primary cluster from the plurality of clusters of the document and subsequently, determine the one or more categories for the document using the representative concepts of the primary cluster of the document. In an embodiment, the one or more rules can include information to determine the one or more categories for the document using the one or concepts of the each cluster of the document. At step 1208, the method 1200 can be configured to classify the document in the one or more categories.

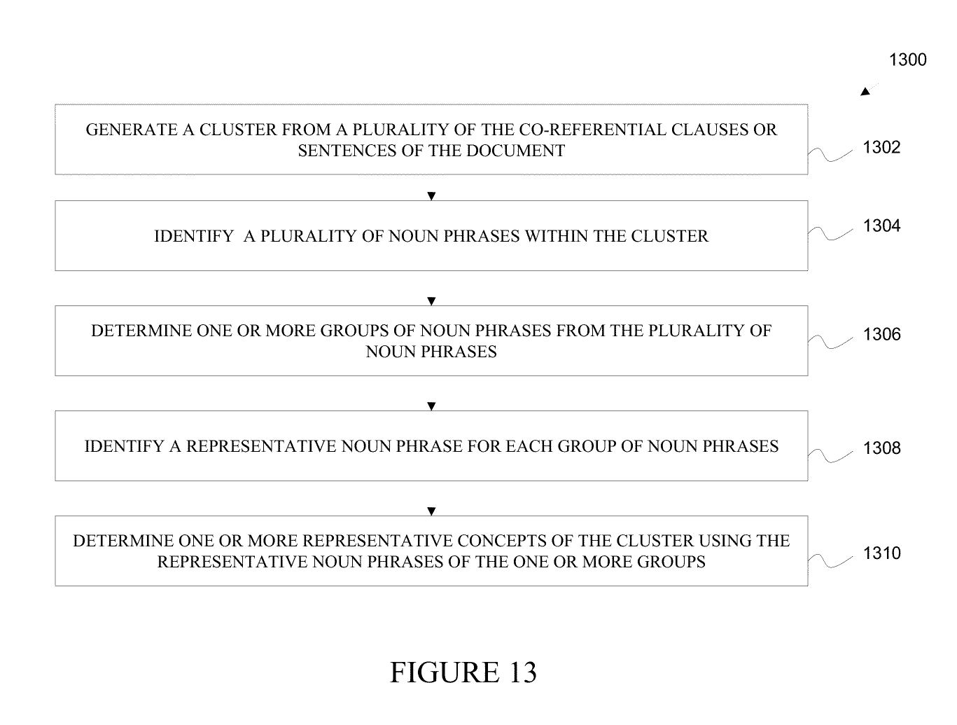

FIG. 13 illustrates a method for determining one or more representative concepts of a cluster of a document according to one or more embodiments of the invention. The method 1300 initiates at step 1302, wherein a cluster is generated from a plurality of the co-referential clauses or sentences of the document. In an example, the cluster can be a clause cluster including the plurality of co-referential clauses of the document. In an example, the cluster can be a sentence cluster including the plurality of co-referential sentences of the document. At step 1304, the method 1300 can be configured to identity a plurality of noun phrases within the cluster. At step 1306, the method 1300 can be configured to determine one or more groups of noun phrases from the plurality of noun phrases such that each noun phrase member in the group is a variant of other noun phrase members of the group. At step 1308, the method 1300 can be configured to identify a representative noun phrase of the each group of noun phrases. In an example, the representative noun phrase of the group of noun phrases can have tokens which are present in the other noun phrase members of the group. At step 1310, the method 1300 can be configured to determine one or more representative concepts of the cluster using the representative noun phrases of the one or more groups.

The methods and systems described herein offers several advantages by deriving the categories for the documents from the semantic analysis of the noun phrases found in the one or more clusters of the document. The methods and systems described herein can classify the document without any need for predetermined categories, which are generally employed by conventional statistical approach for classifying the document. The methods and systems described herein can extract or define categories from the document itself. Further, the methods and systems described herein provide a feature to the user to track the determination of the categories based on which the document has been classified. Furthermore, the methods and systems described herein provide flexibility to the user to classify documents based on the classification rules that can be updated or removed by the user. The user can modify such rules by adding new rule or subtracting existing rule that define criteria for the classification of the document. These features provide a realistic approach for classifying the document over probabilistic statistical approaches that are used conventionally.

Although the foregoing embodiments have been described with a certain level of detail for purposes of clarity, it is noted that certain changes and modifications can be practiced within the scope of the appended claims. Accordingly, the provided embodiments are to be considered illustrative and not restrictive, not limited by the details presented herein, and may be modified within the scope and equivalents of the appended claims.

What is claimed:

1. In a computing environment, a method for classifying a document, the method comprising the steps of:
generating at least one cluster from a plurality of semantically similar clauses of the document;
identifying a first concept from a plurality of concepts of the at least one cluster such that the first concept represents at least a portion of content disclosed in the at least one cluster;
determining a at least one category for the document using the first concept; and
classifying the document based on the at least one category.

2. The method of claim 1, further comprising the steps of:
identifying a first variant of the first concept from a plurality of variants of the first concept within the at least one cluster; and
indicating the first variant of the first concept as a representative of the plurality of variants of the first concept of the at least one cluster.

3. The method of claim 2, wherein the first variant of the first concept comprises a noun phrase.

4. The method of claim 1, further comprising the steps of:
determining a count of variants of each of the concept of the plurality of concepts of the at least one cluster; and
identifying the first concept from the plurality of concepts of the at least one cluster such that the first concept has a highest count of variants.

5. The method of claim 1, wherein the first concept of the at least one cluster comprises at least one attribute of the document.

6. The method of claim 5, wherein the at least attribute of the document is title of the document.

7. The method of claim 1, further comprising the step of:
accessing at least rule to discover other category of the document in an assisted mode of classification of the document.

8. The method of claim 1, further comprising the step of:
modifying the classification of the document in an assisted mode of document classification.

9. The method of claim 1, further comprising the steps of:
determining a second concept from the plurality of concepts of the at least one cluster such that the first concept and the second concept represents at least a portion of content disclosed in the at least one cluster.

10. The method of claim 9, further comprising the step of:
determining the at least one category for the document using the first concept and the second concept.

11. The method of claim 1, further comprising the step of:
determining noun phrases within the at least one cluster to identify the first concept from the plurality of concepts.

12. The method of claim 11, further comprising the step of:
prioritizing noun-phrases that are subjects over the other noun phrases within the at least one cluster while identifying the first concept from the plurality of concepts.

13. The method of claim 1, wherein the generating at least one cluster comprises:
identifying at least one relationship between the at least two clauses or sentences of the document.

14. The method of claim 13, wherein the at least one relationship between the at least two clauses comprises at least one of a co-referential relationship, a conceptual relationship, and an ontological relationship.

15. The method of claim 13, further comprising the step of:
determining anaphoric and cataphoric referential relationships between the at least two clauses of the document.

16. The method of claim 13, further comprising the step of:
managing rules for identifying the at least one relationship between the at least two clauses or sentences of the document in accordance with at least one of: language and domain of the document.

17. The method of claim 13, further comprising the step of:
computing strength of the at least one relationship between the at least two clauses or sentences of the document.

18. The method of claim 1, wherein the at least one cluster is a sentence cluster comprising a plurality of co-referential sentences of the document.

19. The method of claim 1, wherein the at least one cluster is a clause cluster comprising a plurality of co-referential clauses of the document.

20. The method of claim 1, wherein the at least one cluster is a primary cluster.

21. A computer system for classifying a document, the system comprising:
a cluster generating module configured to generate at least one cluster from a plurality of semantically similar clauses of the document, wherein the at least one cluster comprises a plurality of concepts;
a document classifier module comprising:
a cluster concept identifier configured to identify a first concept from the plurality of concepts of the at least one cluster such that the first concept represents at least a portion of content disclosed in the at least one cluster;
a categorizer configured to determine a at least one category for the document using the first concept; and
at least one classification rule comprising instruction to classify the document based on the at least one category.

22. One or more computer-storage media having computer-executable instructions embodied thereon that, when executed, perform a method for classifying a document, the method comprising the steps of:
generating a first cluster from a plurality of co-referential clauses or sentences of the document;
identifying a plurality of noun phrases within the first cluster;
determining at least one group of noun phrases from the plurality of noun phrases such that each noun phrase member in the at least one group is a variant of other noun phrase member of the at least one group;
identifying the at least noun phrase member as a representative of the at least one group; and
determining a first concept representing at least a portion of content disclosed in the first cluster using the representative noun phrase member of the at least one group.

23. The method of claim 22, further comprising the steps of:
determining a second cluster and a corresponding second concept representing at least a portion of content disclosed in the second cluster; and
classifying the document using the first concept and the second concept.
